(19) United States
(12) Patent Application Publication
(10) Pub. No.: US 2017/0150083 A1
(43) Pub. Date: May 25, 2017

(54) VIDEO SIGNAL TRANSMISSION DEVICE, METHOD FOR TRANSMITTING A VIDEO SIGNAL THEREOF, VIDEO SIGNAL RECEPTION DEVICE, AND METHOD FOR RECEIVING A VIDEO SIGNAL THEREOF

(71) Applicant: SAMSUNG ELECTRONICS CO., LTD., Suwon-si (KR)

(72) Inventors: Se-jun KIM, Suwon-si (KR); Chang-yeon CHO, Uijeongbu-si (KR)

(73) Assignee: SAMSUNG ELECTRONICS CO., LTD., Suwon-si (KR)

(21) Appl. No.: 15/359,728

(22) Filed: Nov. 23, 2016

(30) Foreign Application Priority Data
Nov. 23, 2015 (KR) 10-2015-0164130

(51) Int. Cl. H04N 5/38; H04N 19/423; H04N 19/184

(52) U.S. Cl. CPC H04N 5/38; H04N 19/184; H04N 19/423

(57) ABSTRACT

A video signal transmission device, for transmitting additional information through a video signal including an active section where pixel data is transmitted and a blank section where the pixel data is not transmitted, is provided. The device includes a packer configured to receive the video signal and the additional information, and in response to a bit value with respect to the additional information being changed, insert a signal representing a change of the bit value into the video signal, adjust the blank section according to insertion of the signal representing the change of the bit value, and output the video signal where the blank section has been adjusted and an encoder configured to encode the video signal where the blank section has been adjusted.

### CROSS-REFERENCE TO RELATED APPLICATION

This application claims priority from Korean Patent Application No. 10-2015-0164130, filed on Nov. 23, 2015, in the Korean Intellectual Property Office, the disclosure of which is incorporated herein by reference in its entirety.

### BACKGROUND

1. Field

Devices and methods consistent with exemplary embodiments relate to a video signal transmission device, a method for transmitting a video signal thereof, a video signal reception device, and a method for receiving a video signal thereof, and more particularly, to a video signal transmission device for transmitting and receiving a video signal at high speed, a method for transmitting a video signal thereof, a video signal reception device, and a method for receiving a video signal thereof

2. Description of the Related Art

With the development of electronic technologies, various methods for realizing a high-resolution and high-quality image in a display device are being developed.

As the result of the development, a Full High Definition (FHD)-broadcasting service and a Ultra High Definition (UHD)-broadcasting service with resolution four times higher than the FHD are provided in recent years.

Further, with the increase of massive image data, it is required to transmit data at high speed between systems in a display device.

In this regard, a method for using several channels to overcome a limit of a bandwidth for transmission between the systems has been developed, but this method causes interferences between the channels and skew.

Based on the above problems, a serial link method has been developed. According to the serial link method, an image data transmitter serializes and transmits parallel data, and a receiving terminal reconstructs the image data and clock from the received data and parallelizes the serialized data.

However, according to the above serial link method, additional data, for example, error flag or encryption enable signals, may be not transmitted despite the request since there is no data space to which the additional data is inserted.

Accordingly, a method for inserting additional data in an image data transmitter is desired.

### SUMMARY

One or more exemplary embodiments provide a video signal transmission device for inserting additional data into pixel data and image data including a blank section, a method for transmitting a video signal thereof, a video signal reception device, and a method for receiving a video signal thereof.

According to an aspect of an exemplary embodiment, there is provided a video signal transmission device for transmitting additional information through a video signal including an active section where pixel data is transmitted and a blank section where the pixel data is not transmitted. The device includes a packer configured to receive the video signal and the additional information, and in response to a bit value with respect to the additional information being changed, insert a signal representing a change of the bit value into the video signal, adjust the blank section according to insertion of the signal representing the change of the bit value, and output the video signal where the blank section has been adjusted and an encoder configured to encode the video signal where the blank section has been adjusted.

In response to the bit value with respect to the additional information being changed, the packer may adjust the blank section by inserting the signal representing the change of the bit value corresponding to a time when the bit value is changed and adjusting a section between a signal representing a start of the blank section and a signal representing an end of the blank section.

The packer may receive a data enable signal with respect to the video signal, determine a data size, transmittable through adjustment of the blank section, based on the received data enable signal, and insert a signal representing a change of a bit value, with respect to additional information of an amount corresponding to the determined transmittable data size, into the video signal.

The encoder may encode the video signal where the blank section has been adjusted by using an 8b/10b encoding method and encode the signal representing the change of the bit value with respect to the additional information by using a K-code.

According to an aspect of another exemplary embodiment, there is provided a video signal reception device. The device includes a decoder configured to decode an encoded signal and output a video signal where a blank section has been adjusted and an unpacker configured to process the video signal where the blank section has been adjusted and output a video signal and additional information. The video signal where the blank section has been adjusted corresponds to a video signal where the blank section has been adjusted in response to a signal representing a change of a bit value with respect to the additional information being inserted into the video signal, the video signal including an active section where pixel data is transmitted and the blank section where the pixel data is not transmitted.

The unpacker may delay the video signal where the blank section has been adjusted by amounts of different times through a plurality of buffers and generate the video signal and the additional information by selectively using signals outputted from the plurality of buffers.

The unpacker may generate the video signal by selecting a signal outputted from a buffer among the plurality of buffers, and in response to the signal representing the change of the bit value being outputted from the buffer, generate the video signal by selecting a signal outputted from another buffer among the plurality of buffers.

The unpacker may generate the video signal by first using a buffer that outputs a signal having a greatest delay degree among the plurality of buffers.

In response to the signal representing the change of the bit value being outputted from a buffer among the plurality of buffers and the signal representing the change of the bit value being outputted again from the buffer, the unpacker may generate, as the additional information, a signal having an enable state in a section between outputs of the signal representing the change of the bit value.

According to an aspect of still another exemplary embodiment, there is provided a method for receiving a video signal and transmitting additional information through the video signal, the video signal including an active section where pixel data is transmitted and a blank section where the pixel data is not transmitted. The method includes receiving the video signal and the additional information, inserting, in response to a bit value with respect to the additional information being changed, a signal representing a change of the bit value into the video signal and adjusting the blank section according to insertion of the signal representing the change of the bit value, outputting the video signal where the blank section has been adjusted, and encoding the video signal where the blank section has been adjusted.

In response to the bit value with respect to the additional information being changed, the adjusting the blank section may include adjusting the blank section by inserting the signal representing the change of the bit value corresponding to a time when the bit value is changed and adjusting a section between a signal representing a start of the blank section and a signal representing an end of the blank section.

The method may further include receiving a data enable signal with respect to the video signal and determining a data size, transmittable through adjustment of the blank section, based on the received data enable signal. The adjusting the blank section may include inserting a signal representing a change of a bit value, with respect to additional information of an amount corresponding to the determined transmittable data size, into the video signal and adjusting the blank section according to insertion of the signal representing the change of the bit value.

The encoding may include encoding the video signal where the blank section has been adjusted by using an 8b/10b encoding method and encoding the signal representing the change of the bit value with respect to the additional information by using a K-code.

According to an aspect of still another exemplary embodiment, there is provided a method for receiving a video signal. The method includes decoding an encoded signal and outputting a video signal where a blank section has been adjusted and processing the video signal where the blank section has been adjusted and outputting the video signal and additional information. The video signal where the blank section has been adjusted corresponds to a video signal where the blank section has been adjusted in response to a signal representing a change of a bit value with respect to the additional information being inserted into the video signal including an active section where pixel data is transmitted and the blank section where the pixel data is not transmitted.

The outputting the video signal and the additional information may include delaying the video signal where the blank section has been adjusted by amounts of different times through a plurality of buffers and generating the video signal and the additional information by selectively using signals outputted from the plurality of buffers.

The outputting the video signal and the additional information may include generating the video signal by selecting a signal outputted from a buffer among the plurality of buffers, and in response to the signal representing the change of the bit value with respect to the additional information being outputted from the buffer, generating the video signal by selecting a signal outputted from another buffer among the plurality of buffers.

The outputting the video signal and the additional information may include generating the video signal by first using a buffer that outputs a signal having a greatest delay degree among the plurality of buffers.

In response to the signal representing the change of the bit value with respect to the additional information being outputted from a buffer among the plurality of buffers and the signal representing the change of the bit value being outputted again from the buffer, the outputting the video signal and the additional information may include generating, as the additional information, a signal having an enable state in a section between outputs of the signal representing the change of the bit value.

### BRIEF DESCRIPTION OF DRAWINGS

The above and/or other aspects will become apparent and more readily appreciated from the following description of exemplary embodiments, taken in conjunction with the accompanying drawings, in which:

FIG. 1 is a block diagram illustrating a structure of a video signal transmission system according to an exemplary embodiment;

FIG. 2 is a block diagram illustrating a structure of a video signal transmission device according to an exemplary embodiment;

FIGS. 3A and 3B are diagrams provided to describe a method for inserting additional information into a video signal according to an exemplary embodiment;

FIG. 4 is a block diagram illustrating a structure of a video signal reception device according to an exemplary embodiment;

FIG. 5 is a diagram provided to describe an operation of processing a video signal where additional information has been inserted according to an exemplary embodiment;

FIG. 6 is a diagram provided to describe a structure of an unpacker according to an exemplary embodiment;

FIG. 7 is a diagram illustrating a display device according to an exemplary embodiment;

FIG. 8 is a block diagram illustrating a detailed structure of a display device according to an exemplary embodiment;

FIG. 9 is a flowchart provided to describe a method for transmitting a broadcast signal of a broadcast signal transmission device according to an exemplary embodiment; and

FIG. 10 is a flowchart provided to describe a method for receiving a broadcast signal of a broadcast signal reception device according to an exemplary embodiment.

### DETAILED DESCRIPTION

Certain embodiments are described below in greater detail with reference to the accompanying drawings.

The terms used in the following description and claims are widely used common expressions selected by considering functions in various exemplary embodiments. However, such terms may vary depending upon an intention of a person having ordinary skill in the art (hereinafter referred to as ‘those skilled in the art’), legal/technical interpretations, or advent of new technologies. Some of the terms were selected arbitrarily by an applicant, and the terms may be interpreted as defined herein. Unless otherwise defined, the terms may be interpreted based on overall descriptions of the disclosure and common technical knowledge in the art.

In the following description, like drawing reference numerals and symbols refer to the like elements which perform substantially the same function, even in different drawings, for convenience in explanation and for better understanding. That is, although a plurality of drawings share elements having the same reference numerals, the plurality of drawings do not relate to one embodiment.

In the following description and claims, a term including an ordinal, such as, ‘first,’ ‘second,’ or the like, may be used to distinguish elements. The ordinal is used to distinguish the same or similar elements and does not limit the meaning of the term. For instance, ordinals do not affect an order of use or an order of arrangement of elements expressed with the ordinals. Respective ordinals may be replaced with each other, depending on an embodiment.

A term in a singular form includes a plural form unless it is intentionally written that way. In the following description, a term, such as, ‘include,’ consist of,' or the like, refers to the disclosed features, numbers, steps, operations, elements, parts, or combinations thereof and is not intended to exclude any possibilities of existence or addition of one or more other features, numbers, steps, operations, elements, parts, or combinations thereof.

In the following description, a term ‘module,’ ‘unit,’ or ‘part’ refers to an element that performs at least one function or operation. The ‘module’ or ‘unit’ may be realized as hardware, software, or combinations thereof. A plurality of ‘modules,’ ‘units,’ or ‘parts’ may be integrated into at least one module or chip and realized as at least one processor (not shown), except for a case where respective ‘modules’ or ‘units’ need to be realized as discrete specific hardware.

When it is described that one part is connected to another part, the connection includes a direct connection of the parts and an indirect connection through other medium. Further, the expression that a part ‘includes’ a certain element signifies that the part may further include other elements in addition to the certain element, not excluding elements other than the certain element, unless otherwise described.

Further, when it is determined that a detailed description on a related publicly-known technology may obscure the gist of the disclosure unnecessarily, the detailed description will be omitted.

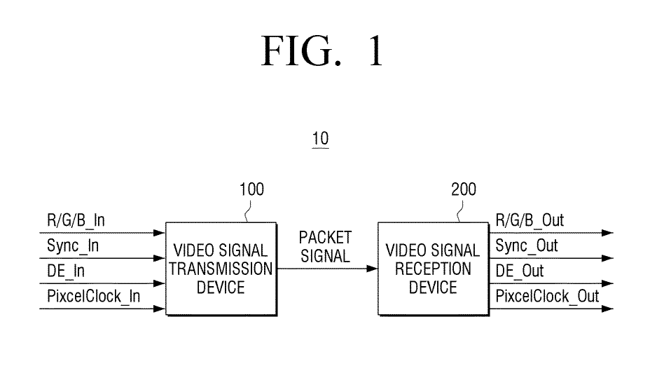

FIG. 1 is a block diagram illustrating a structure of a video signal transmission system 10 according to an exemplary embodiment.

The video signal transmission system 10 may be realized as an interface standard between devices. The interface standard between devices includes various methods, such as, Low Voltage Differential Signaling (LVDS), V-by-One (V×1), V×1 HS, or the like.

In the following disclosure, the interface standard between devices will be described by taking an example of V×1 HS, but this is only an example for illustrative purpose, and other diverse methods may be employed.

Referring to FIG. 1, the video signal transmission system 10 according to an exemplary embodiment includes a video signal transmission device 100 and a video signal reception device 200.

Hereinafter, it is assumed that the video signal transmission system 10 uses the V×1 HS standard method. The V×1 HS standard method performs communication between a video signal transmission device 100 and a video signal reception device 200 using 1 to 32 transmission channels. The V×1 HS standard method may perform high-speed serial transmission by using a Clock Data Recovery (CDR) method since there is no clock line. Further, the V×1 HS standard method is easy to use since the method does not require external control. The V×1 HS standard method is commonly known to those skilled in the art, and thus, a detailed description will be omitted.

The video signal transmission device 100 receives and frame-processes a video signal (R/G/B-In), a synchronizing signal (SYNC_In), a data enable signal (DE_In) and a pixel clock (Pixel Clock_In) of each of R/G/B and transmits a parallel-to-serial converted serial data. A detailed description on the video signal transmission device 100 will be provided below.

The video signal reception device 200 receives a serial signal from the video signal transmission device 100, serial-to-parallel converts the received serial signal, unpacks a frame, and outputs a video signal (R/G/B_Out), a synchronizing signal (SYNC_Out), a data enable signal (DE_Out), and a pixel clock (Pixel Clock_Out) of each of R/G/B. A detailed description on the video signal reception device 200 will be provided below.

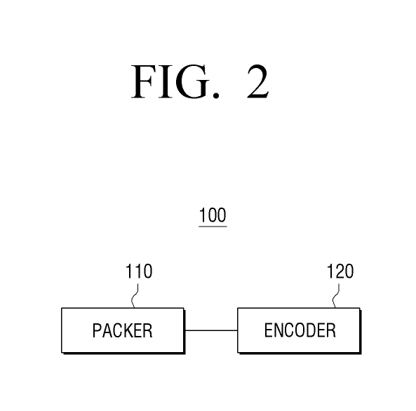

Hereinafter, the video signal transmission device 100 will be described in further detail with reference to FIG. 2.

FIG. 2 is a block diagram illustrating a structure of a video signal transmission device 100 according to an exemplary embodiment.

The video signal transmission device 100 may include a packer 110 and an encoder 120. The video signal transmission device 100 transmits additional information through a video signal including an active section where pixel data is transmitted and a blank section where the pixel data is not transmitted.

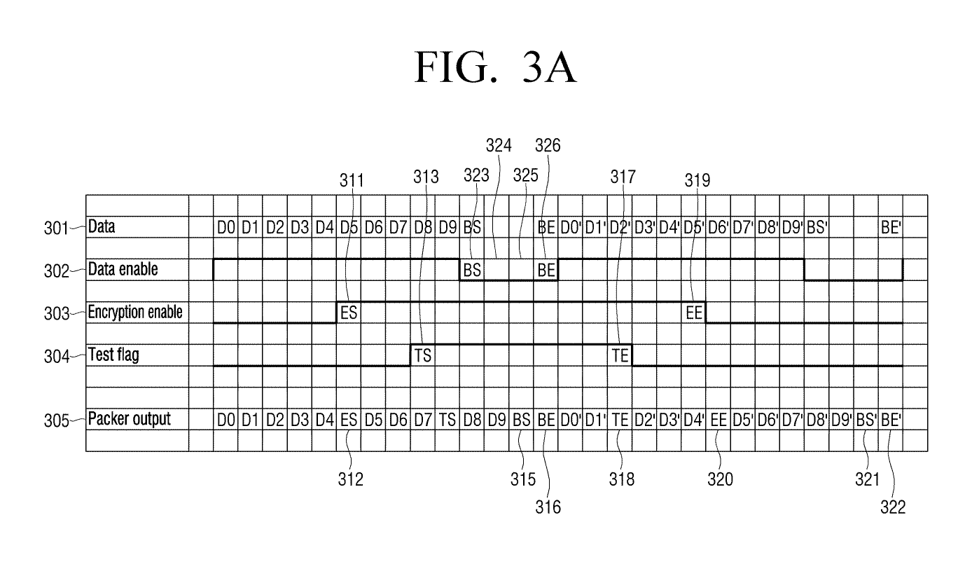

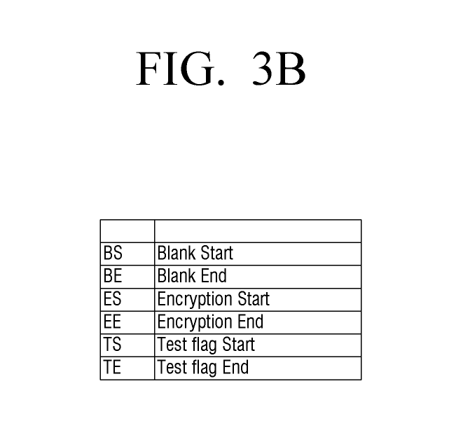

The packer 110 receives the video signal and the additional information. In response to a bit value with respect to the additional information being changed, the packer 110 inserts a signal representing change of the bit value into the video signal, adjusts the blank section according to insertion of the signal representing the change of the bit value, and outputs the video signal where the blank section has been adjusted. This operation will be described below in greater detail with reference to FIGS. 3A and 3B.

FIGS. 3A and 3B are diagrams provided to describe a method for inserting additional information into a video signal according to an exemplary embodiment.

Referring to FIGS. 3A and 3B, ‘BS’ denotes ‘Blank Start,’ ‘BE’ denotes ‘Blank End,’ ‘ES’ denotes ‘Encryption Start,’ ‘EE’ denotes ‘Encryption End,’ ‘TS’ denotes ‘Test flag Start,’ and ‘TE’ denotes ‘Test Flag End.’ Hereinafter, the above abbreviations will be used for convenience in explanation.

In FIG. 3A, a packer 110 receives a plurality of data. In this case, it is assumed that the plurality of data are additional information, for example, an encryption enable signal and a test flag signal, other than pixel data (hereinafter referred to as ‘data’) and a data enable signal. In this case, the pixel data represents an order of pixel values of pixels included in a row line. By way of example, the pixel values may include 12 bits for each of R/G/B and may have a data amount of 36 bits. The encryption enable signal and the test flag signal may be a 1-bit signal. Further, an active section is represented by D0 and D9, and a blank section is represented by BS and BE.

To be specific, in response to a bit value with respect to the additional information being changed, the packer 110 may adjust the blank section by inserting a signal representing change of the bit value corresponding to a time when the bit value is changed and adjusting a section between a signal representing a start of the blank section and a signal representing an end of the blank section.

FIG. 3A is provided to describe a process of generating a video signal in the packer 110. Referring to FIG. 3A, the packer 110 outputs a packer output 305, that is, a video signal where the blank section has been adjusted, based on received data 301, a data enable signal 302, an encryption enable signal 303, and a test flag signal 304.

To be specific, the packer 110 outputs the received data (D0 to D4) sequentially. Subsequently, in response to a bit value of the encryption enable signal which is the additional information being changed first (311), the packer 110 inserts data 312 corresponding to a start of the encryption enable signal at that time and outputs the data. The packer 110 outputs data D5 to D7 next to the outputted data D0 to D4. In response to a bit value of the test flag signal which is the additional information being changed first (313), the packer 110 inserts data 314 corresponding to a start of the test flag signal at that time and outputs the data. Subsequently, the packer 110 adjusts the blank section by an amount of the size corresponding to the inserted data ES and TS and outputs BS and BE on a start point 315 and an end point 316 of the adjusted blank section. Consequently, data D0 to BE corresponding to the pixel values of the pixels included in a first pixel row of a video frame are generated and outputted.

The packer 110 outputs D0′ and D1′ after an output of BE where the blank section ends. In response to the bit value of the test flag signal which is the additional information being changed (317), the packer 110 inserts data 318 corresponding to the end of the test flag signal at that time and outputs the data. Subsequently, the packer 110 outputs data D2′ and D3′ next to the outputted data D0′ and D1′. In response to the bit value of the encryption enable signal which is the additional information being changed (319), the packer 110 inserts data 320 corresponding to the end of the encryption enable signal at that time and outputs the data. Subsequently, the packer 110 adjusts the blank section by an amount of the size corresponding to the inserted TE and EE and outputs BS′ and BE′ on the start point 321 and the end point 322 of the adjusted blank section. Consequently, data D0′ to BE′ corresponding to the pixel values of the pixels included in a second pixel row of the video frame are generated and outputted.

In this case, the packer 110 may receive a data enable signal with respect to the video signal, determine a data size transmittable through adjustment of the blank section, and insert the signal representing the change of the bit value with respect to the additional information corresponding to an amount of the determined transmittable data size into the video signal. For example, the packer 110 may determine the blank sections 323, 324, 325, 326 based on BS 323 and BE 326 of the data enable signal and determine that other parts excluding BS 323 and BE 326 of the blank section are the transmittable data size. In this case, the packer 110 may insert the signal representing the change of the bit value with respect to the additional information into the parts 324, 325.

The encoder 120 encodes the video signal where the blank section has been adjusted. For example, the encoder 120 may encode the video signal where the blank section has been adjusted using an 8b/10b encoding method and encode the signal representing the change of the bit value with respect to the additional information using a K-code (special character). In this case, the 8b/10b encoding method refers to an encoding method of mapping an 8-bit signal onto a 10-bit signal for DC valance or the like.

According to an exemplary embodiment, the video signal transmission device 100 may further include a scrambler (not shown) and a serializer (not shown) in addition to the packer 110 and the encoder 120. In this case, the above components may be arrayed in an order of the packer 110, the scrambler (not shown), the encoder 120, and the serializer (not shown). Some components were described above, and thus, a repeated description on the components will be omitted.

The packer 110 generates a control signal (for example, D/K signal) based on the data enable signal and generates a byte clock based on the number of bytes of a frame. The packer 110 frame-processes the video signal and the synchronizing signal based on the byte clock.

The scrambler (not shown) includes a random number generator. The scrambler (not shown) uses a random number from the random number generator and generates a scramble frame signal by scrambling a frame signal based on the byte clock. The scrambler (not shown) outputs the scramble frame signal and the control signal in the encoder 120.

The encoder 120 encodes the scramble frame signal based on the byte clock and generates the encryption frame signal.

The serializer (not shown) generates a new clock by scaling the byte clock. Further, the serializer parallel-to-serial converts the encryption frame signal based on the new clock.

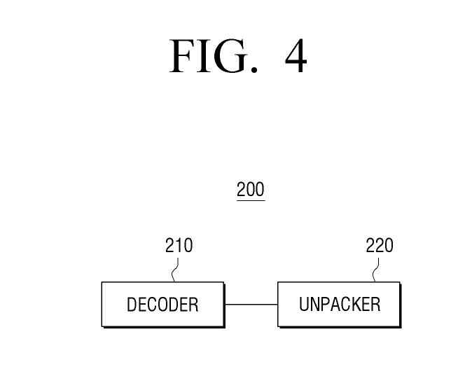

Hereinafter, the video signal reception device 200 will be described in further detail with reference to FIG. 4.

FIG. 4 is a block diagram illustrating a structure of a video signal reception device 200 according to an exemplary embodiment.

Referring to FIG. 4, the video signal reception device 200 includes a decoder 210 and an unpacker 220.

The decoder 210 decodes an encoded signal and outputs a video signal where a blank section has been adjusted. In this case, the video signal where the blank section has been adjusted is a video signal where the blank section has been adjusted as a signal representing change of a bit value with respect to additional information is inserted into a video signal including an active section where pixel data is transmitted and a blank section where the pixel data is not transmitted.

The unpacker 220 may process the video signal where the blank section has been adjusted and output a video signal and additional information.

To be specific, the unpacker 220 may delay the video signal where the blank section has been adjusted by an amount of different times through a plurality of buffers and generate a video signal and additional information by selectively using signals outputted from the plurality of buffers.

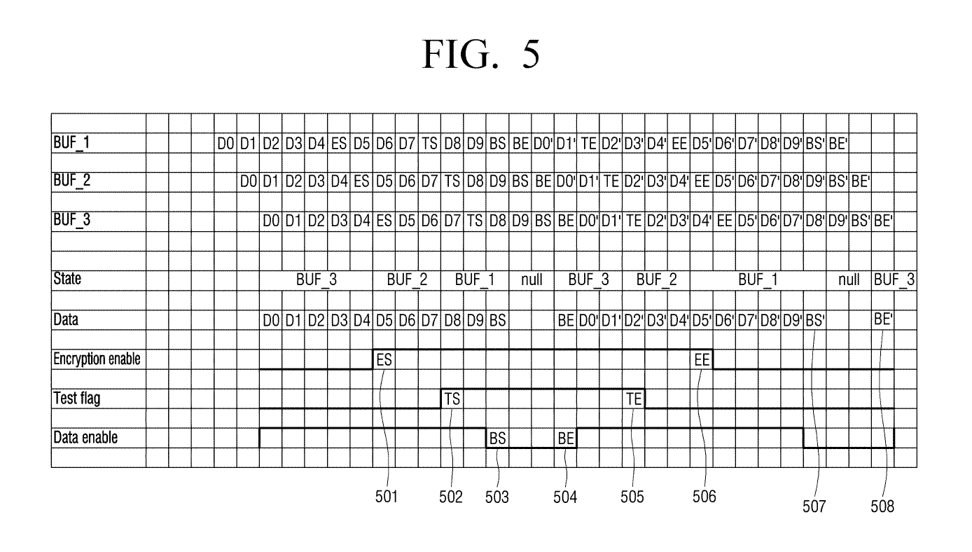

The unpacker 220 may generate the video signal by selecting a signal outputted from one buffer among the plurality of buffers. In response to the buffer that outputs the signal representing the change of the bit value with respect to the additional information, the unpacker 220 may generate the video signal by selecting a signal outputted from another buffer. This operation will be described below in greater detail with reference to FIG. 5.

FIG. 5 is a diagram provided to describe an operation of processing a video signal where additional information has been inserted according to an exemplary embodiment.

Referring to FIG. 5, similar to the embodiment of FIG. 3A, ‘BS’ denotes ‘Blank Start,’ ‘BE’ denotes ‘Blank End,’ ‘ES’ denotes ‘Encryption Start,’ ‘EE’ denotes ‘Encryption End,’ ‘TS’ denotes ‘Test flag Start,’ and ‘TE’ denotes ‘Test Flag End.’ Hereinafter, the above abbreviations will be used for convenience in explanation.

In FIG. 5, an unpacker 220 receives a signal where a blank section has been adjusted. The signal where the blank section has been adjusted includes data and additional data.

The unpacker 220 may include a plurality of buffers. In this case, it is assumed that the plurality of buffers include a first buffer (BUF_1), a second buffer (BUF_2), and a third buffer (BUF_3). In this case, a buffer may be a delay device, for example, a shift register.

A process of extracting pixel data (hereinafter referred to as ‘data’) and additional data will be described below with reference to FIG. 5. The received signal where the blank section has been adjusted is stored in BUF_1, BUF_2, and BUF_3 of the unpacker 220. For example, in response to an initial state being in BUF_3, the unpacker 220 selects and outputs data D0 to D4 stored in BUF_3. In response to a bit value of an encryption enable signal which is the additional information being changed first (501), the unpacker 220 changes the state at that time to select data from BUF_2 having the greater delay degree than BUF_1. That is, the unpacker 220 may generate a video signal by first using a buffer that outputs a signal having the greatest delay degree among the plurality of buffers. Subsequently, the unpacker 220 outputs data D5 to D7 next to the outputted data D0 to D4 from BUF_2.

In response to a bit value of a test flag signal which is the additional information being changed first (502), the unpacker 220 changes the state to select data from BUF_1 at that time. The unpacker 220 selects and outputs data D8 and D9 from BUF_1. In response to BS 503 representing a start of the blank section being inputted, the unpacker 220 maintains a null state. In response to BE 504 representing an end of the blank section being inputted, the unpacker 220 terminates the null state and performs state change for selecting the data of BUF_3.

Subsequently, the unpacker 220 selects and outputs D1′ and D2′ from BUF_3. In response to the bit value of the test flag signal which is the additional information being changed (505), the unpacker 220 performs the state change to select the data of BUF_2. In this case, the unpacker 220 selects and outputs D2′ to D4′ from BUF_2. In response to a bit value of an encryption enable signal which is the additional information being changed (506), the unpacker 220 performs the state change to select the data of BUF_1. In this case, the unpacker 220 selects and outputs data D5′ to D9′ from BUF_1. In response to BS′ 507 representing the start of the blank section being inputted, the unpacker 220 maintains the null state. In response to BE′ 508 representing the end of the blank section being inputted, the unpacker 220 terminates the null state and performs the state change to select the data of BUF_3 again.

In response to the signal representing the change of the bit value with respect to the additional information being outputted from one buffer among the plurality of buffers and then the signal being outputted again from the buffer, the unpacker 220 may generate a signal having an enable state in a section between outputs of the signals as the additional information.

For example, referring to FIG. 5, in response to ES 501 being outputted from BUF_3 and then EE 506 being outputted from BUF_3, the unpacker 220 may generate a signal having an enable state in a section between the output of ES 501 and the output of EE 506 (in this case, the encryption enable signal) as the additional information.

According to an exemplary embodiment, the video signal reception device 200 may further include a parallelizer (not shown) and a de-scrambler (not shown) in addition to the decoder 210 and the unpacker 220. In this case, the above components may be arrayed in an order of the parallelizer (not shown), the decoder 210, the de-scrambler (not shown), and the unpacker 220. Some components are the same or similar to components described above, and thus, a repeated description on the components will be omitted.

The parallelizer (not shown) receives a serial signal from the video signal transmission device 100. In this case, the parallelizer may include Clock Data Recovery (CDR), for example, and serial-to-parallel converts the serial signal based on a clock signal recovered in the CDR, The parallelizer outputs a signal of an encryption packet in the decoder.

The decoder 210 decodes the encryption frame signal based on the recovered byte clock and outputs a scramble frame packet. For example, in response to the decoder 210 using the 8b/10b method, and the encryption frame signal being mapped onto D, the decoder 210 decodes the signal based on mapping of D. In response to the encryption frame signal being mapped onto K, the decoder 210 decodes the signal based on mapping of K.

The de-scrambler (not shown) includes a random number generator corresponding to the random number generator of the scrambler. The random number generator of the de-scrambler is reset based on information included in the scramble frame signal and generates a random number synchronized with the random number generator of the scrambler. The de-scrambler extracts a frame signal using the random number generated in the random number generator of the de-scrambler and outputs the frame signal and a control signal in the unpacker 220.

The unpacker 220 determines the number of bytes of a frame from the control signal and generates a pixel clock by dividing the byte clock according to the determined number of bytes. The unpacker 220 unpacks the frame signal based on the pixel clock and generates the video signal, the synchronizing signal, and the data enable signal of each of R/G/B.

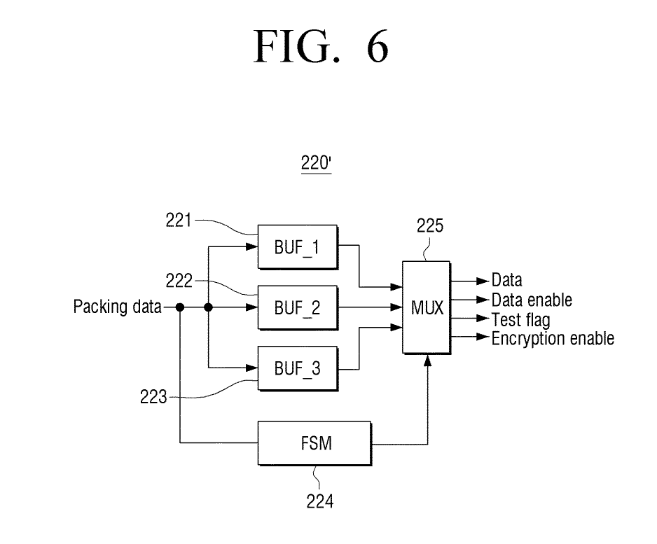

FIG. 6 is a diagram provided to describe a structure of an unpacker 220′ according to an exemplary embodiment.

Referring to FIG. 6, the unpacker 220′ includes a first buffer (BUF_1) 221, a second buffer (BUF_2) 222, a third buffer (BUF_3) 223, a Finite State Machine (FSM) 224, and a multiplexer 225.

The BUF_1 221, the BUF_2 222, and the BUF_3 223 receive packing data sequentially and delay the packing data. In this case, as illustrated in FIG. 5, it is assumed that a delay degree becomes greater in an order of the BUF_3 223, the BUF_2 222, and the BUF_1 221. A description repetitive of the description of FIG. 5 will be omitted.

The FSM 224 changes a state based on additional data included in the packing data.

The multiplexer 225 changes a buffer in response to state change of the FSM 224, receives a signal from the changed buffer, and outputs the received signal.

For example, referring to FIGS. 5 and 6, in response to a bit value with respect to the additional data being changed while the multiplexer 225 receives data from the BUF_3 223, the FSM 224 changes the state so as to receive a signal of the BUF_2 having the greatest delay degree among the plurality of buffers. The multiplexer 225 changes the buffer from the BUF_3 to the BUF_2, receives data from the BUF_2, and outputs the data from BUF_2. Further, the multiplexer 225 divides and outputs the bit value with respect to the additional data.

According to the above process, the data (pixel data), the data enable signal, the test flag signal, and the encryption enable signal are unpacked from the packed data and outputted.

The video signal transmission device 100 and the video signal reception device 200 may be realized as individual chips or realized as a part of an independent component, for example, a display (not shown). Accordingly, the video signal transmission device 100 and the video signal reception device 200 may be included in an electronic device, such as, a display device (not shown) to transmit and receive a video signal.

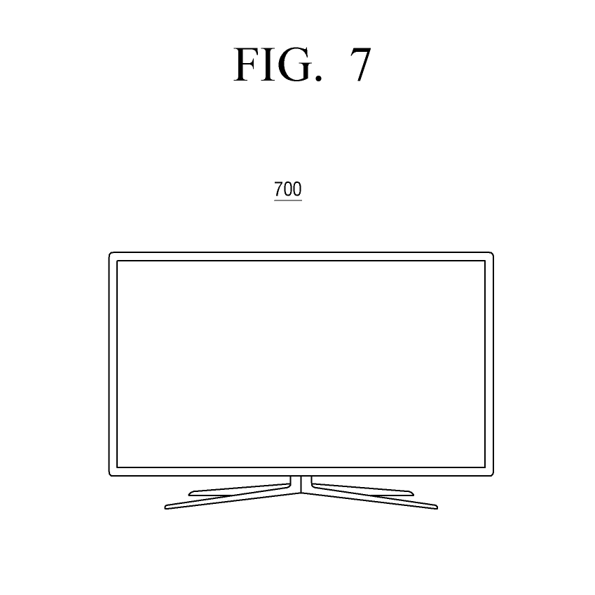

FIG. 7 is a diagram illustrating a display device 700 according to an exemplary embodiment.

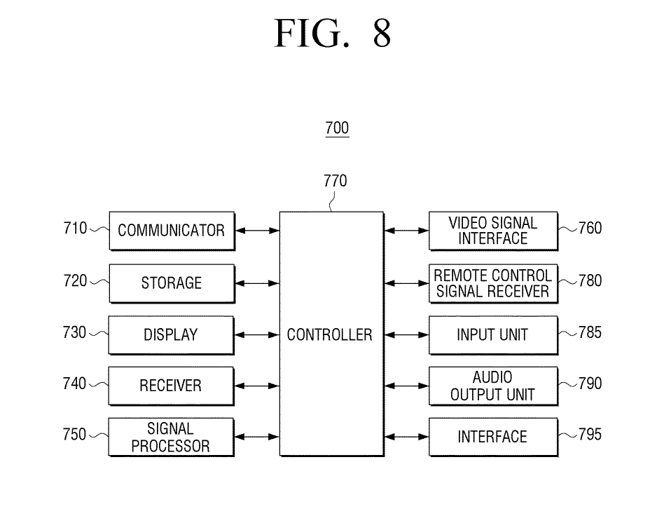

FIG. 7 illustrates a television (TV) 700 as an example of the display device 700. The TV 700 includes a video signal transmission device 100 and a video signal reception device 200. Accordingly, the TV 700 may transmit a video signal between devices using the video signal transmission device 100 and the video signal reception device 200. This operation will be described below in greater detail with reference to FIG. 8.

FIG. 8 is a block diagram illustrating a detailed structure of a display device 700 according to an exemplary embodiment.

Referring to FIG. 8, the display device 700 includes a communicator 710, a storage 720, a display 730, a receiver 740, a signal processor 750, a video signal interface 760, a controller 770, a remote control signal receiver 780, an input unit 785, an audio output unit 790, and an interface 795.

The communicator 710 performs communication through a network (communication network). Particularly, the communicator 710 may perform the communication with diverse external devices (for example, other device and/or a server) connected to the network by using a network address assigned to the display device 700 for the network communication.

In this case, the network address may be an Internet Protocol (IP) address. That is, the communicator 710 may perform the communication with other external device (not shown) connected to an internet network by using the IP address.

Further, the communicator 710 may perform the network communication according to diverse communication methods.

To be specific, the communicator 710 may perform the network communication using diverse communication methods, such as, wired and/or wireless Local Area Network (LAN), Wireless-Fidelity (Wi-Fi), Wide Area Network (WAN), Ethernet, Bluetooth, Zigbee, Universal Serial Bus (USB), IEEE 1394, or the like. The communicator 710 may include various communication modules for performing the network communication according to the respective communication methods. As an example, in response to the network communication being performed according to the wired LAN method, the communicator 710 may include a wired LAN card (not shown). As another example, in response to the network communication being performed according to the Wi-Fi method, the communicator 710 may include a Wi-Fi communication chip (not shown).

The storage 720 stores various data and an Operating System (O/S) for driving and controlling the display device 700.

Further, the storage 720 stores a default program which is executable in the display device 700. In this case, the default program may be an application for providing default functions (or default services) of the display device 700.

To be specific, the default program refers to an application which is initially installed in the display device 700 by a manufacturer in a manufacturing process and is not arbitrarily deletable by a user.

For example, when the manufacturer of the display device 700 provides the default functions, such as, a content retrieve function, a content reproduce function, a search function for various applications installed in the display device 700, an internet access function, and a set-up function, the storage 720 may store the default program for providing the default functions.

The storage 720 may store a downloaded program which is executable in the display device 700. In this case, the downloaded program may be an application for providing other additional functions (or additional services) than the default functions.

To be specific, the downloaded program refers to an application which may be arbitrarily installed or deleted by a user.

For example, the user may download a program for providing the additional functions, such as, a game function, a chat function, or the like, from an external device (not shown) and install the downloaded program in the display device 700. The storage 720 may store the downloaded program.

To this end, the storage 720 may be realized as a storage medium, such as, a non-volatile memory (for example, flash memory), Electrically Erasable Read-Only Memory (EEROM), hard disc, or the like.

The storage 720 may store the default program and the downloaded program in different areas. To be specific, storage 720 may divide a storage area in a storage medium into a plurality of storage areas and store the default program and the downloaded program in the different storage areas. For example, in response to the storage 720 being realized as a flash memory, the storage 720 may store the default program in a first storage area of the flash memory and store the downloaded program in a second storage area of the flash memory. In this case, the storage area for storing the default program may be a storage area that the user is unable to access arbitrarily, and the storage area for storing the downloaded program may be a storage area that the user is able to access. That is, the user is unable to delete the default program stored in the storage area for the default program arbitrarily but is able to delete the downloaded program in the storage area for the downloaded program.

The storage area for the default program may further store diverse data and the O/S for driving and controlling the display device 700, and the data and the O/S may be called ‘firmware.’

However, the above operation is only an example, and the storage 720 may store the default program and the downloaded program in different storage media. That is, in response to the storage 720 being realized as a plurality of flash memories, the default program may be stored in a first flash memory, and the downloaded program may be stored in a second flash memory.

The display 730 displays various screens. To be specific, the display 730 may display a menu for executing the default program. In this case, the menu may include menu items for executing the default program for providing the default functions of the display device 700.

To this end, the display 730 may be realized as Liquid Crystal Display (LCD), Organic Light-Emitting Diode (OLED), Plasma Display Panel (PDP), or the like.

The receiver 740 may receive a broadcast content (or broadcast signal). The broadcast content may include video, audio, and additional data (for example, Electronic Program Guide (EPG)). The receiver 740 may receive the broadcast content from various sources including a terrestrial broadcast, a cable broadcast, a satellite broadcast, an internet broadcast, or the like. As an example, the receiver 740 may receive a video stream where a broadcast content image has been coded.

Further, the receiver 740 may be realized so as to include a tuner (not shown), a demodulator (not shown), an equalizer (not shown), or the like in order to receive a broadcast content transmitted from a broadcasting station.

The signal processor 750 signal-processes the content received through the receiver 740. To be specific, the signal processor 750 may signal-process the content by performing decoding, scaling, frame rate conversion, or the like with respect to videos included in the content such that the content may be outputted to the display 730. Further, the signal processor 750 may signal-process the content by performing decoding or the like with respect to audios included in the content such that the content may be outputted to the audio output unit 790.

The video signal interface 760 transmits a video signal between devices. In this case, the video signal interface 760 may be realized as a plurality of interfaces.

The video signal interface 760 may include the video signal transmission device 100 and the video signal reception device 200. In this case, the video signal transmission device 100 may be installed in a video transmission device (Tx, for example, the controller 770), and the video signal reception device 200 may be installed in a video reception device (Rx, for example, the display 730).

The controller 770 controls overall operations of the display device 700. The controller 770 may include a Central Processing Unit (CPU, not shown), a Read-Only Memory (ROM, not shown), and a Random Access Memory (RAM, not shown) to control the operations of the display device 700.

The ROM stores a command set for system booting or the like. In response to the power being supplied by a turn-on command, the CPU copies the 0/S in the storage 720 to the RAM according to the commands stored in the ROM, and boots up the system by executing the O/S. Upon completion of the boot-up operation, the CPU copies various application programs in the storage 720 to the RAM and executes the programs copied to the RAM to perform various operations.

The CPU accesses the storage 720 and performs a boot-up operation using the O/S in the storage 720. Further, the CPU performs various operations using diverse programs, contents, and data stored in the storage 720.

The remote control signal receiver 780 receives a remote control signal from a remote controller (not shown).

For example, the remote control signal receiver 780 may receive a remote control signal for turning on the display device 700 or displaying the menu. In response to receiving the remote control signal for turning on the display device 700 or displaying the menu, the controller 770 may display the menu for executing the default program. In this case, the controller 770 may configure and display the menu differently depending upon a location of the display device 700.

Further, the remote control signal receiver 780 may receive various remote control signals. For example, the remote control signal receiver 780 may receive a remote control signal for changing a channel or controlling a volume. The controller 770 may change the channel or control the volume of the display device 700 according to the received remote control signal.

The input unit 785 receives various user commands. The controller 770 may execute functions corresponding to the user commands received in the input unit 785.

In response to a user command for turning on the display device 700 or displaying the menu being received through the input unit 785, the controller 770 may display the menu for executing the default program. In this case, the controller 770 may configure and display the menu differently depending upon a location of the display device 700.

Further, the input unit 785 may receive the user command for changing the channel or controlling the volume. The controller 770 may change the channel or control the volume according to the received user command.

The audio output unit 790 may convert an audio signal outputted from the signal processor 750 to sound and output the sound through a speaker (not shown) or an external device connected through an external output terminal (not shown).

The interface 795 connects diverse other devices (not shown) with the display device 700. Further, the interface 795 may transmit the content pre-stored in the display device 700 to other devices (not shown) or receive the contents from other devices (not shown).

For the above operation, the interface 795 may include at least one of a High Definition Multimedia Interface (HDMI) input terminal, a component input terminal, a Personal Computer (PC) input terminal, and a Universal Serial Bus (USB) input terminal.

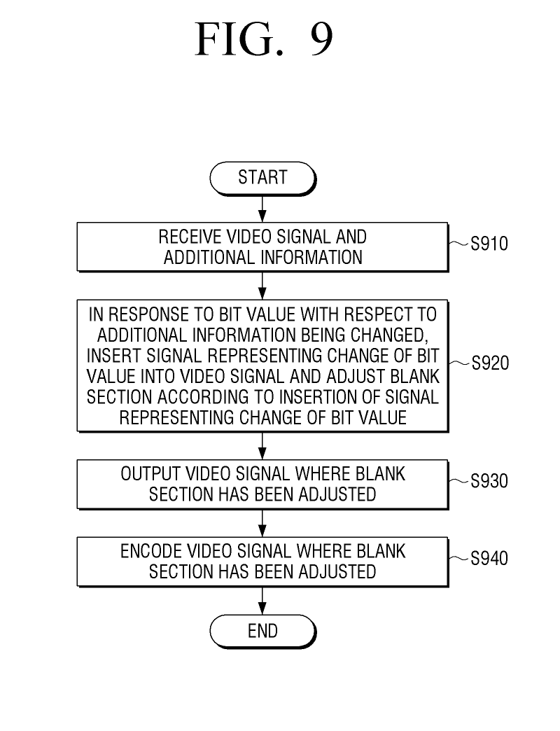

FIG. 9 is a flowchart provided to describe a method for transmitting a broadcast signal of a broadcast signal transmission device 100 according to an exemplary embodiment.

According to the method for transmitting the broadcast signal according to an exemplary embodiment, a video signal and additional information are received (S910). In response to a bit value with respect to the additional information being changed, a signal representing change of the bit value is inserted into the video signal, and a blank section is adjusted according to insertion of the signal representing the change of the bit value (S920). Subsequently, the video signal where the blank section has been adjusted is outputted (S930), and the video signal where the blank section has been adjusted is encoded (S940). In this case, the video signal includes an active section where pixel data is transmitted and the blank section where the pixel data is not transmitted.

In response to the bit value with respect to the additional information being changed, the adjusting the blank section may include adjusting the blank section by inserting the signal representing the change of the bit value corresponding to a time when the bit value is changed and adjusting a section between a signal representing a start of the blank section and a signal representing an end of the blank section.

Further, the method may further include receiving a data enable signal with respect to the video signal and determining a data size transmittable through adjustment of the blank section based on the data enable signal. The adjusting the blank section may include adjusting the blank section by inserting a signal representing change of a bit value with respect to additional information corresponding to the determined transmittable data size into the video signal.

The encoding may include encoding the video signal where the blank section has been adjusted by using an 8b/10b encoding method and encoding the signal representing the change of the bit value with respect to the additional data by using a K-code.

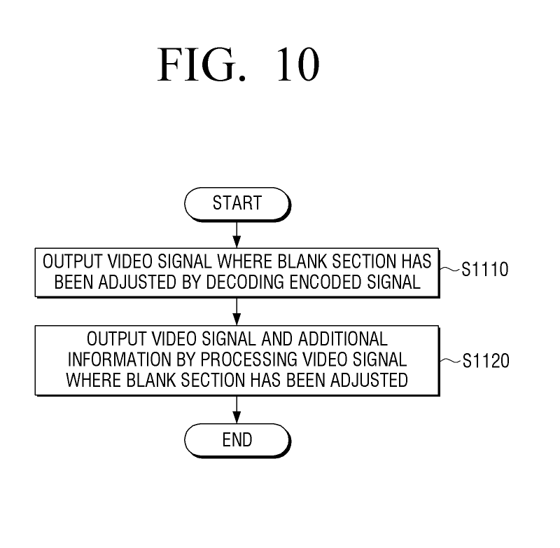

FIG. 10 is a flowchart provided to describe a method for receiving a broadcast signal of a broadcast signal reception device 200 according to an exemplary embodiment.

According to the method for receiving the broadcast signal according to an exemplary embodiment, an encoded signal is decoded to output a video signal where a blank section has been adjusted (S1110). Subsequently, a video signal and additional information are outputted by processing the video signal where the blank section has been adjusted (S1120). In this case, the video signal where the blank section has been adjusted is a video signal where the blank section has been adjusted as a signal representing change of a bit value with respect to the additional information is inserted into a video signal including an active section where pixel data is transmitted and a blank section where the pixel data is not transmitted.

The outputting the video signal and the additional information may include delaying the video signal where the blank section has been adjusted by an amount of different times through a plurality of buffers and generating the video signal and the additional information by selectively using signals outputted from the plurality of buffers.

Further, the outputting the video signal and the additional information may include generating a video signal by selecting a signal outputted from one buffer among the plurality of buffers, and in response to the buffer outputting a signal representing the change of the bit value with respect to the additional information, generating the video signal by selecting a signal outputted from another buffer.

The outputting the video signal and the additional information may include generating the video signal by first using a buffer that outputs a signal having the greatest delay degree among the plurality of buffers.

In response to the signal representing the change of the bit value with respect to the additional information being outputted from one buffer among the plurality of buffers and then the signal being outputted again from the buffer, the outputting the video signal and the additional information may include generating a signal having an enable state in a section between outputs of the signals as the additional information.

According to various exemplary embodiments, a broadcast signal transmission device 100, a method for transmitting a broadcast signal thereof, a broadcast signal reception device 200, and a method for receiving a broadcast signal thereof may be realized as a program code which is executable by a computer and provided to a server or devices through a non-transitory computer readable medium so as to be executed by a packer 110 and an unpacker 220.

As an example, a non-transitory computer readable medium, which stores thereon a program for executing operations of receiving a video signal and additional information, inserting, in response to a bit value with respect to the additional information being changed, the signal representing change of the bit value into the video signal and adjusting a blank section according to insertion of the signal representing the change of the bit value, outputting the video signal where the blank section has been adjusted, and encoding the video signal where the blank section has been adjusted, may be provided.

As another example, a non-transitory computer readable medium, which stores thereon a program for executing operations of outputting a video signal where a blank section has been adjusted by decoding an encoded signal and outputting the video signal and additional information by processing the video signal where the blank section has been adjusted, may be provided.

The non-transitory computer readable medium refers to a medium that stores data permanently or semi-permanently unlike a register, a cache, or a memory that stores data for a short time, and is readable by an apparatus. Particularly, the above-described various applications and programs may be stored in and provided through the non-transitory computer readable r medium, such as, a Compact Disc (CD), a Digital Versatile Disk (DVD), a hard disk, a Blu-ray disk, a Universal Serial Bus (USB), a memory card, a Read-Only Memory (ROM), or the like.

According to the exemplary embodiments, additional data may be transmitted by an amount of a size of a blank section, thereby preventing additional consumption of a bandwidth.

As above, a few embodiments have been shown and described. The foregoing embodiments and advantages are merely exemplary and are not to be construed as limiting the present inventive concept. The present teaching can be readily applied to other types of devices. Also, the description of the embodiments is intended to be illustrative, and not to limit the scope of the claims, and many alternatives, modifications, and variations will be apparent to those skilled in the art.

What is claimed is:

1. A video signal transmission device for transmitting additional information through a video signal, the video signal comprising an active section where pixel data is transmitted and a blank section where the pixel data is not transmitted, the device comprising:
a packer configured to receive the video signal and the additional information, and in response to a bit value with respect to the additional information being changed, insert a signal representing a change of the bit value into the video signal, adjust the blank section according to insertion of the signal representing the change of the bit value, and output the video signal where the blank section has been adjusted; and
an encoder configured to encode the video signal where the blank section has been adjusted.

2. The device as claimed in claim 1, wherein, in response to the bit value with respect to the additional information being changed, the packer is configured to adjust the blank section by inserting the signal representing the change of the bit value corresponding to a time when the bit value is changed and adjusting a section between a signal representing a start of the blank section and a signal representing an end of the blank section.

3. The device as claimed in claim 1, wherein the packer is configured to receive a data enable signal with respect to the video signal, determine a data size, transmittable through adjustment of the blank section, based on the received data enable signal, and insert a signal representing a change of a bit value, with respect to additional information of an amount corresponding to the determined transmittable data size, into the video signal.

4. The device as claimed in claim 1, wherein the encoder is configured to encode the video signal where the blank section has been adjusted by using an 8b/10b encoding method and encode the signal representing the change of the bit value by using a K-code.

5. A video signal reception device, the device comprising:
a decoder configured to decode an encoded signal and output a video signal where a blank section has been adjusted; and
an unpacker configured to process the video signal where the blank section has been adjusted and output a video signal and additional information,
wherein the video signal where the blank section has been adjusted corresponds to a video signal where the blank section has been adjusted in response to a signal representing a change of a bit value with respect to the additional information being inserted into the video signal, the video signal comprising an active section where pixel data is transmitted and the blank section where the pixel data is not transmitted.

6. The device as claimed in claim 5, wherein the unpacker is configured to delay the video signal where the blank section has been adjusted by amounts of different times through a plurality of buffers and generate the video signal and the additional information by selectively using signals outputted from the plurality of buffers.

7. The device as claimed in claim 6, wherein the unpacker is configured to generate the video signal by selecting a signal outputted from a buffer among the plurality of buffers, and in response to the signal representing the change of the bit value being outputted from the buffer, generate the video signal by selecting a signal outputted from another buffer among the plurality of buffers.

8. The device as claimed in claim 7, wherein the unpacker is configured to generate the video signal by first using a buffer that outputs a signal having a greatest delay, among the plurality of buffers.

9. The device as claimed in claim 6, wherein, in response to the signal representing the change of the bit value being outputted from a buffer among the plurality of buffers and the signal representing the change of the bit value being outputted again from the buffer, the unpacker is configured to generate, as the additional information, a signal having an enable state in a section between outputs of the signal representing the change of the bit value.

10. A method for receiving a video signal and transmitting additional information through the video signal, the video signal comprising an active section where pixel data is transmitted and a blank section where the pixel data is not transmitted, the method comprising:
receiving the video signal and the additional information;
inserting, in response to a bit value with respect to the additional information being changed, a signal representing a change of the bit value into the video signal and adjusting the blank section according to insertion of the signal representing the change of the bit value;
outputting the video signal where the blank section has been adjusted; and
encoding the video signal where the blank section has been adjusted.

11. The method as claimed in claim 10, wherein, in response to the bit value with respect to the additional information being changed, the adjusting the blank section comprises adjusting the blank section by inserting the signal representing the change of the bit value corresponding to a time when the bit value is changed and adjusting a section between a signal representing a start of the blank section and a signal representing an end of the blank section.

12. The method as claimed in claim 10, further comprising:
receiving a data enable signal with respect to the video signal; and
determining a data size, transmittable through adjustment of the blank section, based on the received data enable signal,
wherein the adjusting the blank section comprises inserting a signal representing a change of a bit value, with respect to additional information corresponding to an amount of the determined transmittable data size, into the video signal and adjusting the blank section according to insertion of the signal representing the change of the bit value.

13. The method as claimed in claim 10, wherein the encoding comprises encoding the video signal where the blank section has been adjusted by using an 8b/10b encoding method and encoding the signal representing the change of the bit value by using a K-code.
